(19) United States
(12) Patent Application Publication
(10) Pub. No.: US 2005/0083213 A1
(43) Pub. Date: Apr. 21, 2005

(54) System and method for minimizing package delivery time

(76) Inventors: John Stevens, Toronto (CA); Paul Waterhouse, Toronto (CA); Mike Vandenberg, Toronto (CA)

Correspondence Address: MCGINN & GIBB, PLLC, 8321 OLD COURTHOUSE ROAD, SUITE 200, VIENNA, VA, 22182-3817, US

(21) Appl. No.: 10/476,685

(22) PCT Filed: May 7, 2002
(86) PCT No.: PCT/US02/14266

Related U.S. Application Data
(60) Provisional application No. 60/289,138, filed on May 8, 2001.

(51) Int. Cl. G08B 13/14

(52) U.S. Cl. 340/994; 340/571; 340/825.49; 340/572.1; 340/539.2; 701/209

(57) ABSTRACT

An inventive system for delivering packages includes a computer system for determining an optimum route for delivering the package, an electronic tag associated with the package including a first transceiver, and a signaling device. The inventive system also includes a base station having a second transceiver for wirelessly communicating with the first transceiver.

### CROSS REFERENCE TO RELATED APPLICATIONS

This Application claims the benefit of U.S. Provisional Application No. 60/289,138, entitled “SYSTEM AND METHOD FOR MINIMIZING PACKAGE DELIVERY TIME”, which was filed on May 8, 2001 by John Stevens, et al. and assigned to the present assignee, and which is incorporated herein by reference.

### BACKGROUND OF THE INVENTION

1. Field of the Invention

The present invention relates to a system and method for delivering packages, and in particular, a system and method for delivering packages which reduces (e.g., minimizes) a delivery time.

2. Description of the Related Art

When a driver has many packages to deliver in a short period of time, it is important that the package be quickly located. In a typical delivery van, the packages have been pre-sorted into the approximate hour of anticipated delivery. The driver has a printed list of addresses and number of items for each address. The driver drives along the streets until he finds the address, parks the truck, and goes to the back of truck with the printed list.

The driver then sorts through all the packages to find the package having the correct name and address. The driver must also ensure that he has located all of the packages to be delivered to that particular destination. When the driver locates the packages, he must checkoff a list taken to the door at the destination address and obtain a signature or some other indication that the package was delivered.

However, in such a conventional delivery system, locating the proper packages can be difficult. The packages may shift and are not easily located by the driver. Accordingly, the resulting delays can substantially increase the time taken for each delivery and thereby reduce the total number of deliveries that can be made during the driver's delivery run.

### SUMMARY OF THE INVENTION

In view of the foregoing and other problems, disadvantages, and drawbacks of the conventional methods and structures, a purpose of the exemplary aspects of the present invention is to provide a system and method for reducing (e.g., minimizing) a delivery time.

The claimed invention includes an inventive system for delivering packages. The inventive system includes a computer system (e.g., located on a transport vehicle) for determining an optimum route for delivering said package, an electronic tag associated with the package including a first transceiver, and a signaling device. The inventive system also includes a base station having a second transceiver for wirelessly communicating with said first transceiver (e.g., in order to reduce (e.g., minimize) a delivery time). In the inventive system, a signaling device may be activated when the package arrives at a destination, which may help the delivery driver to locate the package in the transport vehicle.

Further, computer system utilizes an electronic positioning system (e.g., a satellite based global positioning system) in order to locate the transport vehicle in real time. Further, the computer system may include a third transceiver for wirelessly communicating with the base station and/or electronic tag.

The system may also include a container for housing the package. In this case, the electronic tag may be affixed to the container. The system may also include a loop antenna located in a transport vehicle which delivers said package. The electronic tag may store an identification number which is unique to a package associated with the electronic tag. The base station may, therefore, wirelessly communicate with the electronic tag using the loop antenna. For example, the base station may causes the electronic tag to activate the signaling device when a destination is reached for a package associated with the electronic tag.

In another aspect, an inventive method for reducing (e.g., minimizing) package delivery time includes inputting a delivery address to a computer system to determine an optimum delivery route, associating an electronic tag with the package, placing the package on a transport vehicle, and activating a signaling device on the electronic tag when the transport vehicle arrives at a destination of the package associated with the electronic tag.

The claimed invention also includes a programmable storage medium tangibly embodying a program of machine-readable instructions executable by a digital processing apparatus to perform a method for reducing (e.g., minimizing) package delivery time.

With its unique and novel aspects, the claimed invention provides a system and method which reduces a package delivery time, thereby resulting in lower cost to the delivery company and ultimately to consumers.

### BRIEF DESCRIPTION OF THE DRAWINGS

The foregoing and other purposes, aspects and advantages will be better understood from the following detailed description of the exemplary aspects of the invention with reference to the drawings, in which:

FIG. 1 illustrates a system 100 for reducing (e.g., minimizing) package delivery time according to the exemplary aspects of the present invention;

FIG. 2 illustrates a container 200 for holding a package to be delivered, according to the exemplary aspects of the present invention;

FIG. 3 illustrates an electronic tag 210 used in the inventive system according to the exemplary aspects of the present invention;

FIG. 4 illustrates the circuitry of the electronic tag 210 used in the inventive system according to the exemplary aspects of the present invention;

FIG. 5 is a flow chart of communications in the inventive system 100 according to the exemplary aspects of the present invention;

FIG. 6 illustrates an electronic tag temporarily affixed to a package as used in the inventive system according to the exemplary aspects of the present invention; and

FIG. 7 is a flow chart illustrating the inventive method according to the exemplary aspects of the present invention.

### DETAILED DESCRIPTION OF THE PREFERRED EMBODIMENTS

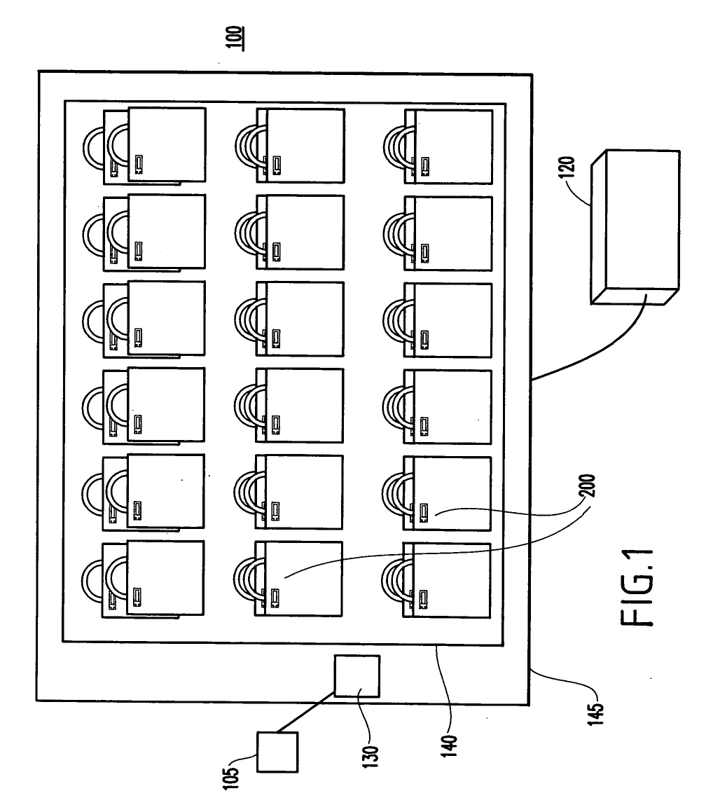

Referring now to the drawings, FIG. 1 illustrates an inventive system 100 for reducing (e.g., minimizing) package delivery time according to the claimed invention.

Generally, the claimed invention includes a semi-automated delivery system that reduces (e.g., minimizes) the time required for a delivery driver to deliver packages. The inventive system 100 may select an optimum route for the driver, identify the correct packages to be delivered at each destination, and verify that the package was actually delivered.

As shown in FIG. 1, the inventive delivery system 100 may utilize a two-way inductive wireless communication system. Specifically, the delivery system 100 includes an electronic positioning system 105 (e.g., a satellite-based global positioning system (GPS)), to verify the location of the transport vehicle 145.

The delivery system 100 also includes a computer system 130 which may be located, for example, on a transport vehicle 145 used to deliver a package (e.g., packages). The computer system 130 may monitor the location of the transport vehicle using the electronic positioning system 105 (e.g., a GPS receiver may be located on the transport vehicle 145). The inventive delivery system 100 may also include a base station 120 which may wirelessly communicate with the computer system 100 on the transport vehicle to optimize a delivery route.

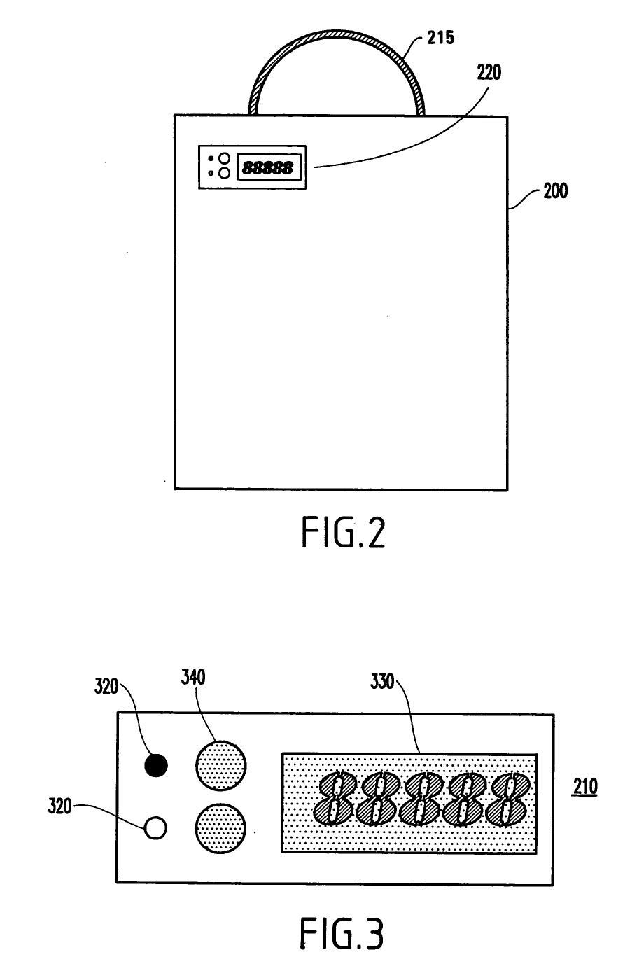

The inventive system 100 may further include a container 200 (e.g., a plurality of containers) (e.g., bags or totes) which contains a package(s) to be delivered to a destination using, for example, a transport vehicle. As shown in more detail in FIG. 2, the container 200. may be made from materials such as cloth (e.g., canvas) or plastic (e.g., nylon), and may include a support device 215 (e.g., a support strap) attached to the container 200 (e.g. at the top of the container) for easily storing the container (e.g., on a rack in a transport vehicle) and transporting the container 200 (e.g., by hand-carrying the container).

Further, as shown in FIG. 3, a small electronic tag 210 (i.e., electronic module) may be associated with a container. In addition, the electronic tag (e.g., electronic module) 210 may also be similar in form and function to the electronic tag described in Stevens, et al., U.S. patent application Ser. No. 10/474,353, entitled “TOTE-BASED WAREHOUSING SYSTEM AND METHOD”, which was filed on Oct. 9, 2003, and the electronic tag described in Stevens, et al., U. S. patent application Ser. No. ______, entitled “DELIVERY SYSTEM AND METHOD USING AN ELECTRONIC TAG”, which was filed on Nov. 3, 2003, and which are commonly assigned with the present application, and are incorporated herein by reference.

Further, the electronic tag 210 may be located, for example, in a small translucent pocket 220 on the container 200. The tag may include a signaling device (e.g., a plurality of signaling devices) such as a colored (e.g., red or green) light emitting device 320 (e.g., a light emitting diode (LED) or an audible signaling device). The electronic tag 210 may also include a display 330 such as a liquid crystal display (LCD) for numeric or alphanumeric display, and a switch (e.g., plurality of switches or buttons) 340 for controlling an operation of the electronic tag 210.

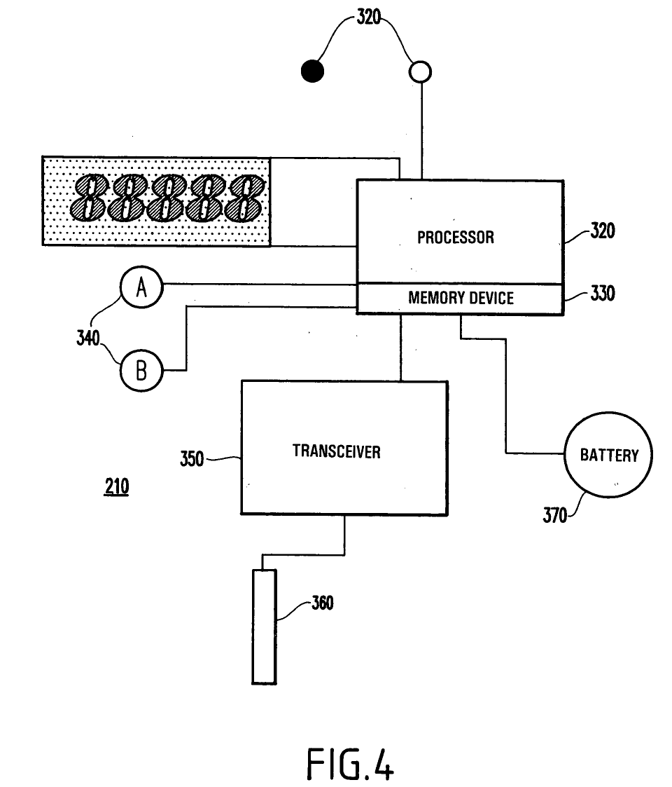

FIG. 4 provides a more detailed description of the electronic tag 210. As shown in FIG. 4, the electronic tag 210 additionally may include an inexpensive processor 320 (e.g., a low powered four bit microprocessor), a memory device 330 (e.g., a random access memory (RAM)) or other nonvolatile memory device for storing a unique identification number. The identification number may be permanent, so that it can be changed only with a special program and transmitter.

The electronic tag 210 may also contain a transceiver 350 (e.g., a two-way communication chip) for allowing the electronic tag 210 to wirelessly communicate (e.g., via a radio frequency (RF) link) with other objects, such as the base station 120. The two-way communications chip may be, for example, a lowcost CMOS analog digital chip. The two-way communications chip may be connected to orthogonal ferrite antennas 360 that are able to transmit and receive signals using low frequencies to the loop antenna (e.g., in the transport vehicle) wirelessly connected to the base station.

Further, a loop antenna 140 may be located on the transport vehicle 145 in order to facilitate a two way communication between the electronic tag(s) 210 and the base station 120. Although the loop antenna 140 is illustrated in FIG. 1 as surrounding the containers 200, this should not be considered as limiting. For example, one of ordinary skill in the art would readily understand that such a loop antenna may be much smaller and need only have a size sufficient for performing the tasks of the inventive system 100.

More specifically, the electronic tag 230 may wirelessly communicate with the base station 120 via a bi-directional wireless link. The wireless link may include, for example, a low frequency conductive loop requiring minimal power and allowing communication within a predetermined area. Further, the LCD 330 may be programmed to display both numeric as well as alphanumeric information transmitted to the electronic tag (e.g., electronic module) via the base station 120. The circuitry may be solar powered or powered, for example, by a battery 370 or other power source. Battery life using conventional alkaline batteries is likely to exceed five years, and with AAA batteries the life may be longer.

In the inventive system 100, the container 200 may be loaded with a package(s), for example, at a distribution center or warehouse facility. The packages may then be transferred onto a transport vehicle where the packages are sorted and placed (e.g., on shelves) in the transport vehicle. The location of the containers on the transport vehicle can be random or predetermined.

The electronic tag 210 may be used to help direct the placement of packages at predetermined locations on the transport vehicle. For example, a package's proper location on the transport vehicle may be displayed on the LCD 330 so that it may be easily viewed, for example, by package handlers at the distribution center. For instance, the packages may be sorted and shelved on the transport vehicle, for example, by destination.

Further, the location of a package (e.g., location code) on the transport vehicle may be determined so as to reduce (e.g., minimize) driver time. For example, the location may be determined based upon, for example, the route the transport vehicle must take to deliver all the packages.

The packages (e.g., containers) can be placed from left to right, front to back, upper to lower or lower to upper or in any other order, according to such factors as the destination of the package or the anticipated time of delivery. For example, the earliest or closest deliveries may start on the lower left side of the transport vehicle and proceed up and right along the wall of the transport vehicle so that the latest or farthest deliveries would be located on the lower right side of the transport vehicle.

Therefore, the delivery driver does not have to know what package is to be delivered to a particular destination. Instead, the driver may make a delivery knowing, for example, a package located at a particular location on the transport vehicle is to be delivered to a particular destination.

In addition, using the loop antenna 140, the base station 120 may poll all of the electronic tags 210 in the inventive system 210 in search of a particular electronic tag 210 and communicate only with that particular tag. For instance, the base station 120 may poll each of the electronic tags 210 located near (e.g., within range of) the loop antenna 140 on the transport vehicle 145. Thus, the base station 120 is capable of placing specific information on the display 330, activating/deactivating the signaling device (e.g., flashing the light emitting diodes 320), selectively activating the electronic tags 210 contained in the containers 200 on the vehicle.

For instance, the GPS coordinates of a destination (e.g., delivery address) may be known in advance. The containers with packages may be loaded onto racks at a distribution center and placed in the transport vehicle. The loop antenna 140 may, for example, be wired around the back and/or top of the rack holding the containers. The loop antenna 140 is wirelessly connected to the base station 120 which can transmit and receive (e.g., via RF link) to the electronic tags 210 included in the loop.

The electronic tags 210 may have unique identification numbers. Thus, the base station 120 may poll the electronic tags 210 in the loop (e.g., in the transport vehicle) for a specific identification number, and then communicate only to that specific electronic tag. For example, the base station may place specific information on the display of the electronic tag, and/or activate or deactivate the signaling device (e.g., LED), while selectively polling the electronic tags.

The containers may be packed in an optimal manner at the distribution center using a similar arrangement. For example, an optimal route may be calculated using the electronic positioning system 105 for the destinations (e.g., delivery addresses) of the container. A sequence number may be displayed on the electronic tag 210 indicating the relative positions for containers in the transport vehicle.

Alternatively, the route may be calculated and a specific position for placing the container in the transport vehicle may be displayed on the electronic tag's display (e.g., LCD). Further, the container with the first destination may be placed on the first rack, on the first hook, the second container can be placed on the same rack on the same hook, a third container on the next hook, and so on. These shelf positions may be indicated by a sequence of digits, one-one, one-two, and so on.

Further, the inventive system 100 may include several hardware and software components. As shown in FIG. 5, routing software 510 (e.g., executed by the computer system 130) may be used to calculate an optimal route based on the GPS coordinates of the destination (e.g., the delivery address where the package is to be delivered).

A global positioning system 520 (GPS), may detect the location of a transport vehicle in realtime. A mapping guidance system 530 may also be used to direct the driver to the correct address. This is particularly important if the system is used for nighttime delivery when addresses and street signs are not normally visible. A database 540 holding the correct container and the ID for the tag attached to the container plus the GPS address is also stored on the computer 130 (as shown in FIG. 1).

The computer 130 may also include, for example, a display 545 (e.g., a laptop computer with a flat panel display) which may be located (e.g., temporarily located) near the delivery driver in the transport vehicle. In addition, the computer 130 may include a transceiver 550 (e.g., RF transmitter and receiver) for wirelessly communicating with other objects, such as the base station 120.

The base station 120 similarly may include a transceiver allowing it to wirelessly communicate with the electronic tags 210 in the inventive system 100 by the unique ID number of the tags. Thus, the inventive system 100 can activate a signaling device (e.g., an LED) on a particular container 200 or package when the delivery driver arrives at the destination for that particular package.

The inventive system 100 may also determine an optimal route for the transport vehicle. An optimal route may be used, for example, to reduce (e.g., minimize) time or distances traveled by the transport vehicle. The optimal route may be determined, for example, using the electronic positioning system 105 (e.g., GPS) and the coordinates or addresses of each package's destination.

The optimal route may be, for example, input into the computer system 130 which may also be located on the transport vehicle. The ID numbers of the electronic tags 210 can also be loaded into the computer system 130. The GPS system can also be used to guide the transport vehicle to a package's destination via a map, or other conventional routing software. When the transport vehicle arrives at a package destination, the computer system 130 can alert the driver, for example, audibly or by displaying a text message on the computer system display 545. The message to the driver may include, for example, the destination address, the number of packages to be delivered, and the package's location on the transport vehicle.

In addition, the computer system 130 (or the base station 120 by using the loop antenna 140) may cause the electronic tag 210 on the container 200 in which the package is located, to be activated so as to facilitate locating the package by the driver. For example, the signaling device (e.g., light emitting device or audible device or combination thereof) on the electronic tag 210 may be activated so that the driver can easily locate the package. The driver can locate the container 200 with the activated signal (e.g., a flashing light), remove the package from the container 200 and deliver it to its destination.

The driver may also activate the switch 340 (e.g., a button) on the electronic tag 210 to indicate that the package has been properly delivered to its destination. In addition, if for some reason the package could not be delivered, the driver may place the package back into the container and activate a switch (e.g., on the container) to indicate that delivery was attempted but unsuccessful.

Further, additional information can be displayed on the LCD 330 of the electronic tag 210 at different times. For example, after the container 200 is loaded on the transport vehicle, the number of packages contained in the container 200 can be displayed so the driver can periodically check the contents of each container 200.

Furthermore, when the container 200 is empty, the driver may deactivate the electronic tag 210 using an activation switch 340 (e.g., a button) on the electronic tag 210. The electronic tag 210 may also be automatically deactivated, for example, by placing the container 200 and/or the electronic tag 210 at a particular location on the transport vehicle which may house a short-range antenna emitting a deactivation signal. In addition, the computer system 130 wirelessly communicates with the electronic tag and may, therefore, detect that the container is no longer in use.

The container 200 used by the inventive system may include, for example, a tote. In this case, the electronic tag may be located, for example, on the front of the tote. In addition, a simple, inexpensive electronic tag may contain a single LED to facilitate locating the package by the delivery driver.

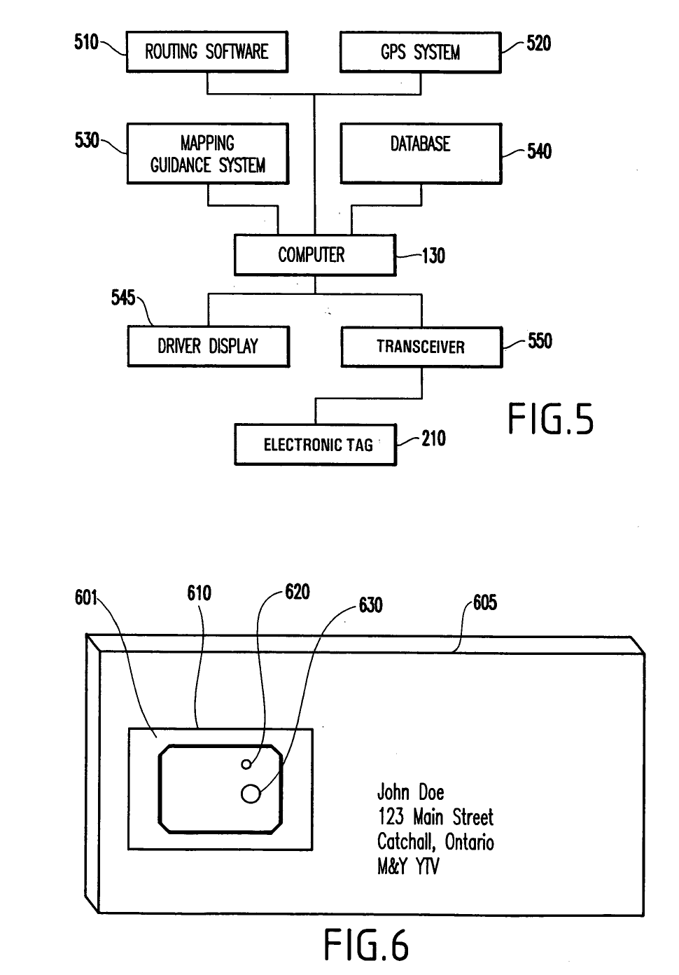

Further, as shown in FIG. 6, an electronic tag 601 may be placed, for example, not on the container but instead, directly on the package 605. In this case, the driver may remove the tag 601 as the package is delivered to its destination, and place the tag in a special bin located, for example, in the transport vehicle. Further, the electronic tag 601 may be placed on the package using an adhesive pouch 610 having a plastic window.

Tag 601 might be very flat like a credit card with only a single light emitting diode 620, and a small switch 630 (e.g., button) and in all other respects is the same as the electronic tag 210 in FIGS. 3 and 4. The switch 630 may be used for confirmation delivery, or alternatively to allow the tag 601 to be used as an access card to open an electronic drop box at the package's destination.

For example, the driver may activate the switch 630 (e.g, push a button) on the tag to gain access to the drop box. The tag 210 on the package wirelessly communicates with the drop box causing the drop box to unlock. After the driver places the package 605 in the drop box, the tag 210 may be removed and placed in a bin located, for example, on the transport vehicle. In addition, the driver may deactivate the tag 210 to indicate that the tag 210 is no longer in use and/or that the package 605 was properly delivered, using the switch 630 on the electronic tag 210. Further, the tag may include a memory which records, for example, the date and time that the tag was used to open the drop box.

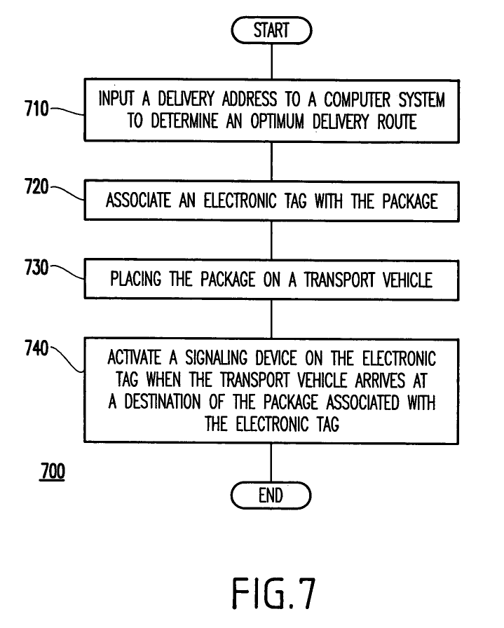

The claimed invention also includes an inventive method 700 for delivering packages. As shown in FIG. 7, the inventive method 700 may include inputting (710) delivery addresses to a computer system to determine an optimum delivery route. The inventive method 700 also includes associating (720) an electronic tag with the package, placing (730) the package on a transport vehicle, and activating (740) a signaling device on a particular electronic tag when the transport vehicle arrives at a destination of a package contained within a container having that particular electronic tag.

With its unique and novel aspects, the claimed invention provides a system and method which reduces (e.g., minimizes) a packaging delivery time, thereby resulting in lower cost to the delivery company and ultimately to consumers.

While a preferred embodiment of the present invention has been described above, it should be understood that it has been provided as an example only. Thus, those skilled in the art will recognize that the invention can be practiced with modification within the spirit and scope of the appended claims.

Further, Applicant's intent is to encompass the equivalents of all claim elements. No amendment to any claim in the present application should be construed as a disclaimer of any interest in or right to an equivalent of any element or feature of the amended claim.

1. A system for delivering a package comprising:
a computer system for determining an optimum route for delivering said package;
an electronic tag associated with said package comprising:
a first transceiver; and
a signaling device; and
a base station comprising a second transceiver for wirelessly communicating with said first transceiver.

2. The system according to claim 1, wherein said signaling device is activated when said package arrives at a destination.

3. The system according to claim 1, wherein said computer system is located on a transport vehicle used to transport said packages.

4. The system according to claim 3, wherein said computer system utilizes an electronic positioning system in order to locate said transport vehicle in real time.

5. The system according to claim 4, wherein said electronic positioning system comprises a global positioning system.

6. The system according to claim 4, wherein said computer system comprises a third transceiver for wirelessly communicating with at least one of said base station and said electronic tag.

7. The system according to claim 1, further comprising:
a container for housing said package,
wherein said electronic tag is affixed to said container.

8. The system according to claim 1, wherein said electronic tag is affixed directly onto said package.

9. The system according to claim 1, further comprising:
a loop antenna located in a transport vehicle which delivers said package,
wherein said base station wirelessly communicates with said electronic tag using said loop antenna.

10. The system according to claim 1, wherein said base station causes said electronic tag to activate said signaling device when a destination is reached for a package associated with said electronic tag.

11. The system according to claim 1, wherein said electronic tags stores an identification number which is unique to a package associated with said electronic tag.

12. A method for reducing package delivery time comprising:
inputting a delivery address to a computer system to determine an optimum delivery route;
associating an electronic tag with said package;
placing said package on a transport vehicle; and
activating a signaling device on said electronic tag when said transport vehicle arrives at a destination of said package associated with said electronic tag.

13. The method according to claim 12, wherein said signaling device comprises one of a light emitting device and an audible device.

14. The method according to claim 12, wherein an electronic positioning system is used to locate a transport vehicle delivering said package in real time.

15. The method according to claim 14, wherein said electronic positioning system comprises a global positioning system.

16. The method according to claim 12, wherein said transport vehicle comprises a computer system which wirelessly communicates with at least one of said base station and said electronic tag.

17. The method according to claim 12, wherein said package is housed in a container, and wherein said electronic tag is affixed to said container.

18. The method according to claim 12, wherein said electronic tag is affixed directly onto said package.

19. The method according to claim 12, wherein said transport vehicle comprises a loop antenna, and wherein a base station wirelessly communicates with said electronic tag using said loop antenna.

20. A programmable storage medium tangibly embodying a program of machine-readable instructions executable by a digital processing apparatus to perform a method for reducing package delivery time, said method comprising:
inputting a delivery address to a computer system to determine an optimum delivery route;
associating an electronic tag with said package;
placing said package on a transport vehicle; and
activating a signaling device on said electronic tag when said transport vehicle arrives at a destination of said package associated with said electronic tag.
